(19) United States
(12) Patent Application Publication
(10) Pub. No.: US 2011/0246218 A1
(43) Pub. Date: Oct. 6, 2011

(54) PRESCRIPTION FULFILLMENT APPARATUS AND METHOD

(76) Inventor: Dan G. Starko, Franklin, TN (US)

(21) Appl. No.: 13/011,625

(22) Filed: Jan. 21, 2011

Related U.S. Application Data
(63) Continuation-in-part of application No. 13/007,650, filed on Jan. 16, 2011.
Application No. 13/007,650 is a continuation-in-part of application No. 11/618,941, filed on Jan. 2, 2007.

(51) Int. Cl. G06Q 50/00; G06Q 10/00

(52) U.S. Cl. 705/2

(57) ABSTRACT

A system for fulfillment by a medical products supplier of medical prescriptions issued by a prescriptionist for patients with reimbursement by a third party provider, in which a patient has a prescription authorization card having an electronically addressable memory encoded with patient medical information including medical history, images, and a medical prescription selectively recorded into the memory by a data station and communicating the prescription to the medical products supplier and a distributor that provides the medical product from the medical products supplier to the patient upon presentation of the prescription authorization card to the distributor, a second data station configured for authenticating the fulfillment and delivery of the medical product to the patient, with the prescription authorization card including a connector for selecting connection and communication of medical information from the memory to an authorized accessor.

The present application is a continuation-in-part of co-pending U.S. patent application Ser. No. 13/007,650, filed Jan. 16, 2011, a continuation-in-part of co-pending U.S. patent application Ser. No. 11/618,941 filed Jan. 2, 2007.

### TECHNICAL FIELD

The present invention relates to apparatus and methods for fulfilling medical prescriptions. More particularly, the present invention relates to an integrated system including memory devices containing selectively written patient medical information for access and fulfillment by medical products providers of medical prescriptions issued to patients or for access to medical services information.

### BACKGROUND

Persons experiencing physical and or mental anomalies frequently are attended by medical physicians for the purpose of diagnosis and treatment. Treatment incorporates a variety of regulated courses or regimen intended to preserve or restore health or to obtain some result such as mitigation, control, or remediation of the underlying matter. Frequently, physicians or prescriptionists prescribe treatments that include the use of medicants at particular specified dosage rates, frequencies, and durations. The physician develops a prescription for addressing the needs of the patient. The physician writes the instructions for the medical prescription on a sheet of a prescription pad. The prescription sheet contains an identification of the physician and the instructions as to the medicant, the amount, the dosage, the frequency, the duration, and special instructions related to the medicant. The patient then undertakes to have the prescription fulfilled at a pharmacy.

There are a variety of pharmacies which provide prescription fulfillment services. These include drug counter services in grocery stores, as well as retail drug stores and apothecaries. In an effort to reduce costs of medicants and fulfillment services, some medical insurance plans provide for a centralized prescription fulfillment center. The original prescription issued by the doctor is delivered by the patient by mail to the central prescription fulfillment center. Thereafter, refills of the prescription (if permitted by the original prescription issued by the physician) can be obtained by telephone or written instruction.

The patient receiving the prescription must also attend to payment for these products. In some instances, payment can be coordinated directly by the physician's staff with the insurance carrier or other funding source. In many instances however, the patient pays the cost of the prescription, and seeks reimbursement from the insurance carrier or other funding entity as appropriate.

While this process provides for delivery of medicants pursuant to written instructions from medical doctors and reimbursement as appropriate, there are drawbacks to this system. Notwithstanding the experience and skill of the pharmacist, the written prescription may be difficult to read leading to errors in dosage, frequency, duration, and special instructions, if not otherwise detected. In addition, there are time delays between the delivery of the prescription to the pharmacist for fulfillment, and availability of the fulfilled prescription. Also, prescription records must be maintained reflecting the medicants ordered, delivered, and paid for, by the prescribing physician, by the pharmacy, and by the funding source.

Also, communication of medical information about a patient often requires the patent to provide duplicative information such as during an initial visit. Medical records, images, and test results require transfer among medical treating personnel, and without prompt access to a patients medical history, images, and tests, diagnosis and treatment may be inappropriate or treatments may be counterproductive.

Accordingly, there is a need in the art for an improved apparatus and methods of providing access to patent medical records within a medical prescription fulfillment system with a convenient apparatus readily usable by medical personal, medical prescription suppliers, insurance carriers, and patients to obtain and use patient medical information. It is to such that the present invention is directed.

### SUMMARY OF THE INVENTION

The present invention meets the need in the art by providing a system for fulfillment of medical prescriptions issued by a prescriptionist for one of a plurality of patients and fulfilled by a medical products supplier, comprising a plurality of prescription authorization devices, each having an electronically addressable memory configured for receiving at least a medical prescription and a unique identifier associated with one of a plurality of patients for whom medical prescriptions are issued by a prescriptionist. A first data station is interactively operative for encoding the electronically addressable memory of the prescription authorization device a medical prescription for the patient by the prescriptionist. A communicator is configured for communicating the medical prescription from the prescription authorization device to a medical products supplier. The patient identifies a distributor for providing the medical product subject of the medical prescription from the medical products supplier to the patient. A second data station configured for encoding by the distributor in the electronically addressable memory the delivery and fulfillment information for the medical prescription.

In another aspect, the present invention provides a system for fulfillment of medical prescriptions issued by a prescriptionist for one of a plurality of patients with reimbursement by a third party provider and fulfilled by a medical products supplier, comprising a plurality of prescription authorization cards, each having an electronically addressable memory and a unique identifier associated with one of a plurality of patients for whom medical prescriptions are issued by a prescriptionis. A data station interactively operative for encoding the electronically addressable memory of the prescription authorization card with a medical prescription for the patient by the prescriptionist. A communicator accessible by the patient and configured to access the medical prescription as encoded in the memory of the prescription authorization card and to communicate the medical prescription to the medical products supplier. A data storage device accessible by the medical products supplier and configured to record the medical prescription together with the identifier sent by the communicator for tracking the status of fulfillment of the medical prescription. An electronic notice system communicates an availability message to the patient upon fulfillment of the medical prescription. The patient being notified of the fulfillment of the medical prescription, uses the communicator to authorize delivery of the medical prescription and the communicator further configured to encode delivery and fulfillment information for the medical prescription in the electronically addressable memory of the prescription authorization card.

In another aspect, the present invention provides a medical information system in which a plurality of authorized accessors including prescriptionists that issue medical prescriptions for a plurality of patients for fulfillment by a medical products supplier, in which each patient is provided with a prescription authorization device comprising a housing with an embedded memory device and including a unique identifier associated with a one of a plurality of patient. An electronic device configured for selectively reading and writing patient medical information in the memory device is also configured for communicating through a communications network with a plurality of accessors that include at least one precriptionist, a medical provider, and a distributor that provides the prescribed medical product to the patient. The memory device is configured with a database of patient information, accessor information, and prescription information of a medical prescription, in which the patient information including at least a number of a payment account which upon authorization is accessed for payment of a co-payment or a balance due for the medical prescription entered by one of the prescriptionists into the memory device and fulfilled by a medical provider, and the patient information further selectively including medical history information, allergy and reaction information, medical images related to the patient, medical reports, and medical tests, whereby a referred prescriptionist or an emergency medical personnel as one of the accessors may access through a second electronic device the information recorded in the memory device of the prescription authorization device.

In another aspect, the present invention provides a method of information exchange in a medical information system in which a plurality of authorized accessors including prescriptionists issue medical prescriptions for a plurality of patients for fulfillment by a medical products supplier, in which each patient is provided with a prescription authorization device comprising the steps of:

(a) providing to each of a plurality of patients a separate prescription authorization device that includes an embedded electronic memory device having at least a unique identifier associated with the one of the plurality of patents;

(b) configuring an electronic device for selectively reading and writing patient medical information in the memory device and for communicating through a communications network with a plurality of accessors including at least one prescriptionist, a medical provider, and a distributor that distributes a medical product prescribed by the prescriptionist to the patient;

(c) providing the memory device with patient information, accessor information, and prescription information;
the patient information including at least a number of a payment account which upon authorization is accessed for payment of a co-payment or a balance due for the product subject of the medical prescription entered by the one of the prescriptionists into the memory device and fulfilled by the medical provider; and
the patient information further selectively including medical history information, allergy and reaction information, medical images related to the patient, medical reports, and medical tests,

whereby a referred prescriptionist or an emergency medical personnel as one of the accessors may access through a second electronic device the information recorded in the electronic memory device of the prescription authorization device.

Objects, features, and advantages of the present invention will become readily apparent upon reading of the following detailed description in conjunction with the drawings and the appended claims.

### BRIEF DESCRIPTION OF THE DRAWINGS

FIG. 1 illustrates in schematic view an apparatus for medical prescription fulfillment according to the present invention.

FIG. 2 illustrates in schematic view a prescription authorization card for interactive use with the apparatus for medical prescription fulfillment illustrated in FIG. 1.

FIG. 3 illustrates a method for medical prescription fulfillment according to the present invention.

FIG. 4 illustrates an embodiment of a prescription authorization card for use in accordance with the present invention.

### DETAILED DESCRIPTION

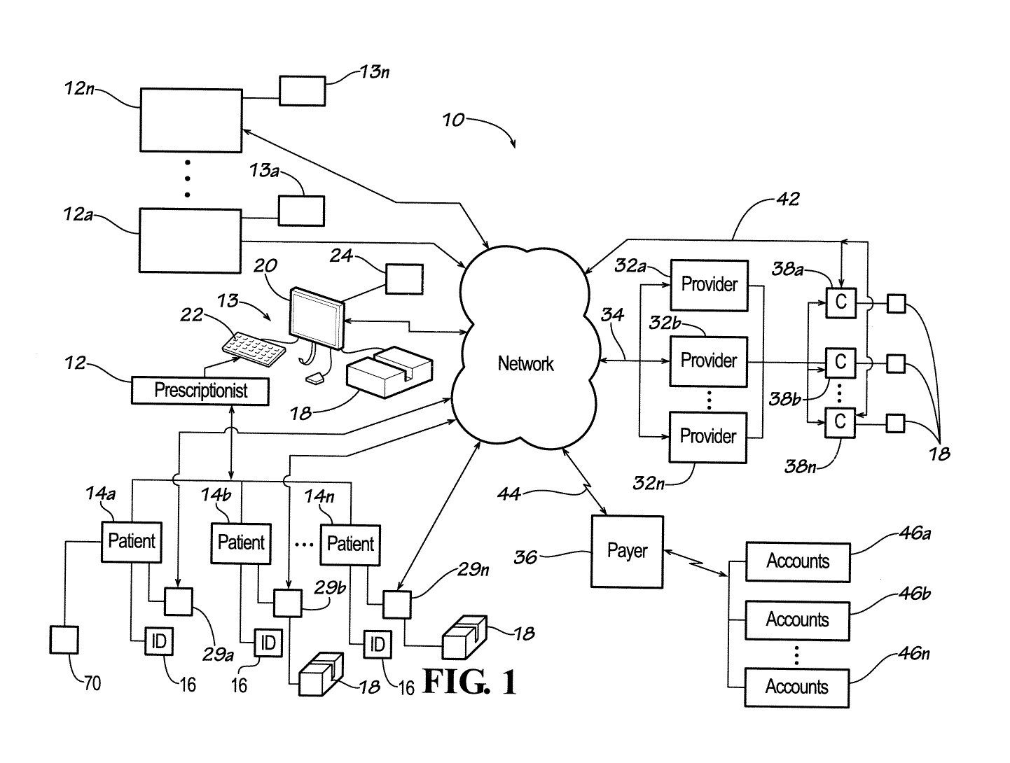

With reference to the drawings in which like reference numerals indicate like parts, FIG. 1 illustrates in schematic view a system 10 for medical prescription fulfillment according to the present invention. The system 10 includes a plurality of prescriptionists 12 (one is illustrated), for example, a treating physician, authorized to issue medical prescriptions to a plurality of patients 14. Each prescriptionist 12, treating physician, other medical personnel, medical products provider, medical products distributor operative with in the system 10 has network communications equipment generally 13 discussed below or access to such equipment for authorized proper access to records of the system. Each patient 14 is provided with a prescription authorization card 16.

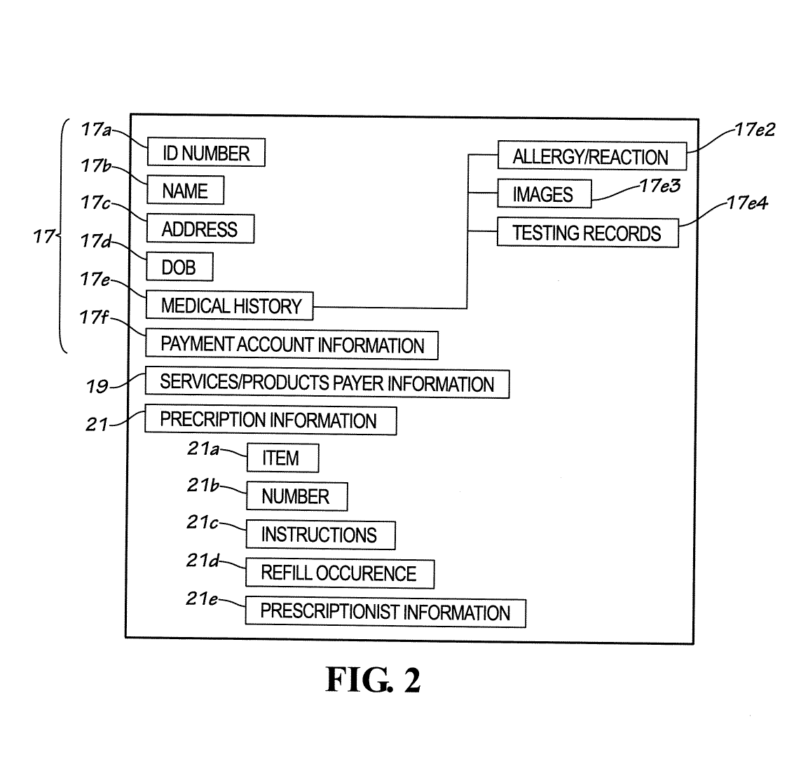

As illustrated in schematic view in FIG. 2, the prescription authorization card 16 is encoded with unique information including patient information generally 17, third party information generally 19, and prescription information generally 21 associated with the patient 14. As discussed below, this encoding in the illustrated embodiment involves writing the information into an electronic memory device of the prescription authorization card 16. This information includes, for example, an identification number 17a, name 17b, address 17c, date of birth (DOB) 17d, and other pertinent information 17e including as appropriate medical history generally 17e1 including without limitation diagnosis, analysis, notations and comments, allergy and reaction information 17e2, scanned medical diagnostic images generally 17e3 including without limitation x-ray, sonograph, radiography, magnetic resonance (MRI), nuclear, photoacoustic, thermography, tomography, and measurement and recording test information 17e4 including without limitation electroencephalography (EEG), magnotoencephalography (MEG), elecrtrocardiography (EKG), and others, and other appropriate medically significant information.

The patient information 17 in an alternate embodiment includes a payment account number 17f such as a credit or debit account number for payment of prescription products with the system 10. Payment is authorized upon presentation of the prescription authorization card 16 as a debit or credit card linked to the payment account number 12f. This payment authorization may include payment of a co-pay by the patient from the account and/or authorization for payment of a balance due for the prescription cost by a third party payer such as an insurance plan administrator or other third party payor. Alternatively, payment of co-pay and/or balance may be authorized upon electronic access to the prescription authorization card through an electronic device or a configured card reader that may access the memory of the card 16. The prescription authorization card 16 also may contain the identification 19 of the medical services and products payer, such as an insurance carrier or other funding entity to which medical suppliers and providers can seek reimbursement, including address and account numbers as appropriate.

The prescription authorization card 16 also contains the prescription information generally 21 including an item identification 21a, an amount 21b, special instructions 21c, refill occurrence availability 21d, and prescriptionist information 21e including name, identification number, contact numbers such as telephone or email, and other appropriate information.

With continuing reference to FIG. 1, the prescription authorization card 16 as discussed above includes an electronically addressable memory. The prescription authorization card 16 may be provided in different housings or embodiments, including a plastic card or sheet member configured with an electronically encoded or read memory device, such as a magnetic strip or an electronic memory device, a card member configured configured with a microprocessor device including an electronic memory (for example, and without limitation, such card member referred to in the electronic microprocessor art as a “smart” card), an electronic memory device having a conventional communications connector such as a USB memory stick or device for portable transport of digital information, or other memory device for receiving, recording, being accesses, and communicating digital information. The term “prescription authorization card” accordingly refers broadly to a portable, electronically writable, electronically readable memory devices for storage and access to patent information, payor information, and prescription information. There are conventional electronic devices 18 configured to read or access the memory device, such as the magnetic strip, the “smart” card, and the USB (or other connector) device.

The patient information 17, the payer information 19, and the prescription information 21 are stored in the memory. The memory in the prescription authorization card 16 is accessible by an electronic device 18 as part of the network communication equipment 13. The electronic device 18 is configured for interactive reading and writing to the card 16 by authorized assessors such as the prescriptionists 12, physicians, and others (providers, distributors, and other authorized medical personnel operative within the system 10). Conventional security systems for electronically coded information including passwords, audit tracking, encryption and other techniques, are gainfully employed for confidentiality and control purposes. The electronic device 18 communicates with a microprocessor computer 20 having a conventional keyboard and mouse 22 for input of information by the prescriptionist 12 to a patient management system 24 accessible through the computer 20. The computer 20 is configured to communicate by a communications link 26 with a network 28 such as the worldwide web or other network system.

Each of the patients 14 may have a networking device 29 such as a personal computer located at home or business configured for network communications, or alternatively has access to such networking device such as a publicly available computer. Each such network device 29 selectively may include one of the electronic card reading/writing devices 18. The database or patient management system 24 operates with a computer configured with a prescription control system through which the device 18 may access information held in memory or under instructions of an authorized information provider may update or write information to the electronic memory of the prescription authorization card 16, as discussed below.

The system 10 includes a plurality of medical products providers generally 32. Each provider 32 communicates by a communications link 34 to the network 28 for interactive communications with prescriptionist 12 and other entities in the system 10 such as a payer 36 and distributors 38. The provider 32 may selectively access the patent management system 24, or alternatively maintain a prescription database for tracking prescriptions, fulfillment, and payments. The distributors 38 interact 40 directly with the providers 32 and communicate 42 with the network 28. In one embodiment of the system 10, each distributor 38 includes one of the electronic devices 18 for reading and as appropriate writing to the prescription authorization card 16 of the patient 14. The payer 36 includes a communications link 44 with the network 28 for interactive access to accounts 46 associated with the provider 32 and the distributors 38, as appropriate. The prescription authorization card 26 is accessed for the patient information 17, the payer information 19 and the prescription information 21.

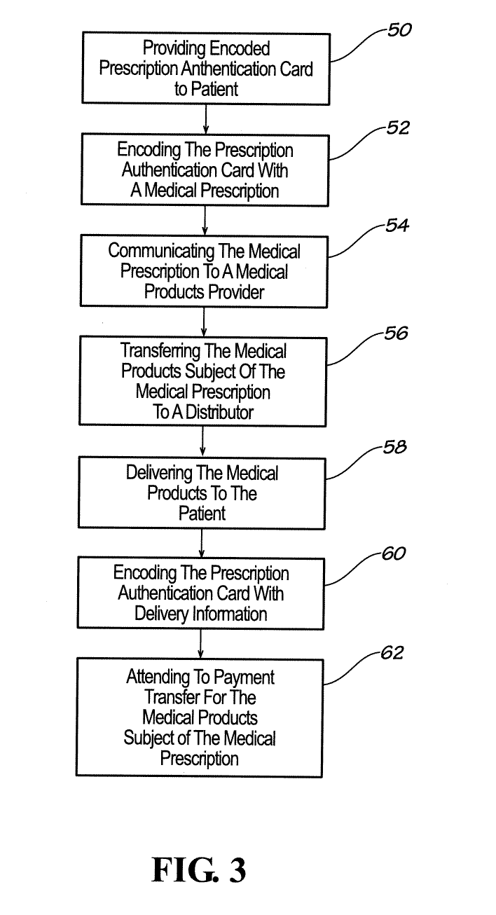

FIG. 3 illustrates a process flow for the method and system for fulfillment of medical prescriptions issued by the prescriptionist 12 for the patient 14, and in an alternate embodiment of the system 10, with reimbursement by a third party to the medical products supplier 32 such as by the payer 36 identified on the prescription authorization card 26 payer information 19. The method provides 50 an encoded prescription authentication card 16 to the patient 14. From time-to-time and as appropriate, the prescriptionist 12 encodes 52 the prescription authentication card 16 with a medical prescription for the patient 14 including the prescription information 21. The electronic device 18 operated by the patient management system 24 enables the prescriptionist 12 to enter using the keyboard and mouse 22 the medical prescription information 19 including the prescription item 21a, the dosage rate and amount 21b, refill authorization 21d, and special instructions 21c such as frequency, duration associated with the medical prescription for the patient 14, and other prescription information as necessary. In addition, the patient management system 24 communicates 54 the medical prescription information 21 to a medical products provider 32. This may be accomplished by the precriptionist 12 operating the card reader 18 at the time of encoding the card 12, or alternatively by the patient 14 using the card reader at a home computer 29. Further, the patient 14 can select a drugstore convenient to the patient's home or business for delivery of the medical product. The information database maintained in a computer complex of the medical products provider 32 receives the medical prescription. In the illustrated embodiment, the patient management system 24 communicates by the link 26 through the network 28 and the links 34 with the medical products provider 32.

The medical products provider 32 uses the medical prescription information in the database and prepares the medical product subject of the medical prescription. The medical products provider 32 transfers 56 the medical products to a distributor 38. The transfer includes a medical prescription report detailing the medicant and instructions by the prescriptionist 12 as to dosage, frequency, duration, refill authorization, and special instructions. It is to be appreciated that the distributor 38 may be a pharmacy service associated with the medical products provider 32, such as a transaction window located at the medical products provider which is accessible to the patient 14. The distributor 38 can also be a pharmacy or a drug store selected by the patient, or a products carrier such as a mail service or delivery service.

The distributor delivers 58 the medical products to the patient. In one aspect of the system 10, the patient provides the prescription authentication card 16 for confirmation of the request for the prescription. The distributor 38 uses the electronic device 18 to authenticate and verify the delivery, and encodes 60 the prescription authentication card 16 with delivery information related to providing the medical products to the patient. Upon delivery, the payments are made for the prescription product. In one aspect, the distributor 38 effects communication through the link 42 and the network 28 to the payer 36 that attends to payment transfer from appropriate accounts 46 for the medical products delivered to the patient 14, such as a debit or credit card. In another aspect, the patient 14 may pay the cost directly and seek reimbursement from a third party payer, if available separately.

It is to be appreciated that the encoding step 52 and communicating step 54 may be reversed in order to encode the prescription in the memory of the prescription authentication card 16 following a confirmation from the medical products provider 32 of receipt into the information database of the medical prescription communicated by the prescriptionist 12.

Further, the patient 14 readily accesses the database of the medical products provider 32 to place orders for refills if permitted according to the refill occurrence availability 21d indicated on the prescription authentication card 16. This can be accomplished through interactive access via the network 28 and accessible computer devices 29 and communication channels for accessing web sites on the network, by telephonic interactive identification and confirmation systems, or other communications devices including written media or personal presence.

In the illustrated embodiment, the patient 14 may use the card device 18 with the computer 29 to access the patient and prescription information encoded in the memory of the prescription card 16. The patient and prescription information communicates to the medical products provider. The medical products provider 32 uses the patient information 17 and the prescription information 21, for example, for initial orders or for refill orders, including confirmation with the prescriptionist 12 using the prescriptionist information 21e if necessary.

In another aspect, the prescriptionist information 21e enables billing deductible payments back through the prescriptionist 12 for payment by third party provider. This is accomplished by the distributor communicating with the prescriptionist after delivery of the medical prescription. Alternatively, the card reader 18 operated by the patient 14 obtains the account information from the prescription authorization card 16 as a debit or credit card for payment of the prescription from an account associated with the account number held in the memory of the card.

In an alternate embodiment of the system, the medical products provider 32 communicates an electronic message to the patient 14 upon preparation of the medical product subject of the prescription. In the illustrated embodiment, the medical products provider 32 communicates an email message to a messaging system of the patient. Alternatively, the electronic message may be a text message to a portable computer device 70 (shown in FIG. 1 associated with the patient 14a) such as a personal data apparatus or PDA, a voice message to a wireless telephone, or other such messaging system. The patient 14 being notified of the fulfillment of the medical prescription uses the card reader device 18 as a communicator to authorize delivery of the medical prescription. The prescription fulfillment system communicates through the card reader device 18 to encode the delivery and fulfillment information for the medical prescription in the electronically addressable memory of the prescription authorization card 16.

In an alternate embodiment, the medical product provider contacts the third party provider for authorization prior to proceed with delivery and release of the prescription medical product to the patient.

In one aspect, the system 10 facilitates communication of medical information expeditiously. The patient 14 being referred to another medical provider or physician for example a specialist 12a, readily provides his medical information to the specialist by presentation of the prescription authorization card 16. The patient identification information 17 including medical history 17e communicates or up-loads from the prescription authorization card 16 to the local computerized records of the referred medical provider 12a. This transfer of information reduces paperwork and duplicative completing of patient information forms and entry of patient information usually required upon an initial visit to a new medical provider. The medical history 17e1, allergy information 17e2, images 17e3 and testing results 17e4 is transferred and readily available. In emergency events such as the patient being unconscious or otherwise incapable of communication, medical personnel can access the prescription authorization card 16 to obtain relevant and current medical information for treatment purposes. For example, and without limitation, a recent EKG report for a patient 14 can be compared to EKG test during an emergency evaluation. The referred medical provider or the emergency treating medical providers thereby have access to the patient 14 current medical history information.

The medical information system operates to provide intercommunications for plurality of authorized accessors that includes prescriptionists 12 who issue medical prescriptions for patients 12 for fulfillment by the medical products supplier 32, medical products distributors, and referred prescriptions or medical services providers. Each of the patients 12 is provided with one of the prescription authorization cards 16 having the embedded memory device and including the unique identifier 17 associated with the patient. The electronic device 18 selectively reads and writes patient medical information 17, 19, and 21 in the memory device of the prescription authorization card 16. The prescription authorization card 16 is configured for communicating through the communications network with a plurality of authorized accessors. The memory device of the prescription authorization card 16 is configured with a database of patient information, third party information, and prescription information, in which the patient information includes at least the number of the payment account 17f, which upon authorization is accessed for payment of the co-payment or the balance due for the medical prescription 21 entered by one of the prescriptionists 12 into the memory device and fulfilled by the medical provider 32. The prescription authorization card 16 further selectively includes medical history information, allergy and reaction information, medical images related to the patient, medical reports, and medical tests. The prescriptionist 12, a referred prescriptionist or emergency medical personnel as one of the accessors may access through the second electronic device 18 the patient information recorded in the memory device of the prescription authorization card 16.

A method of information exchange in the medical information system 10 is provided for the plurality of authorized accessors including prescriptionists 12 to issue medical prescriptions for the patients 12 for fulfillment by the medical products supplier 32. Each patient is provided with a unique prescription authorization card 16 that includes the identifier associated with the patent. The embedded memory device is configured for selectively reading and writing by the electronic device 18 so that patient medical information in the memory device can be accessed and communicated through a communications network with the accessors. The memory device receives patient information, third party information, and prescription information, including at least the number of the payment account, which upon authorization, is accessed for payment of the co-payment and/or the balance due for a medical prescription entered by one of the prescriptionists 12 into the memory device and fulfilled by the medical provider 32. The patient information further selectively includes medical history information, allergy and reaction information, medical images related to the patient, medical reports, and medical tests, whereby the accessor such as the prescriptionist 12, a referred prescriptionist or emergency medical personnel may access through a second electronic device 18 the patient information recorded in the electronic memory of the prescription authorization card 16.

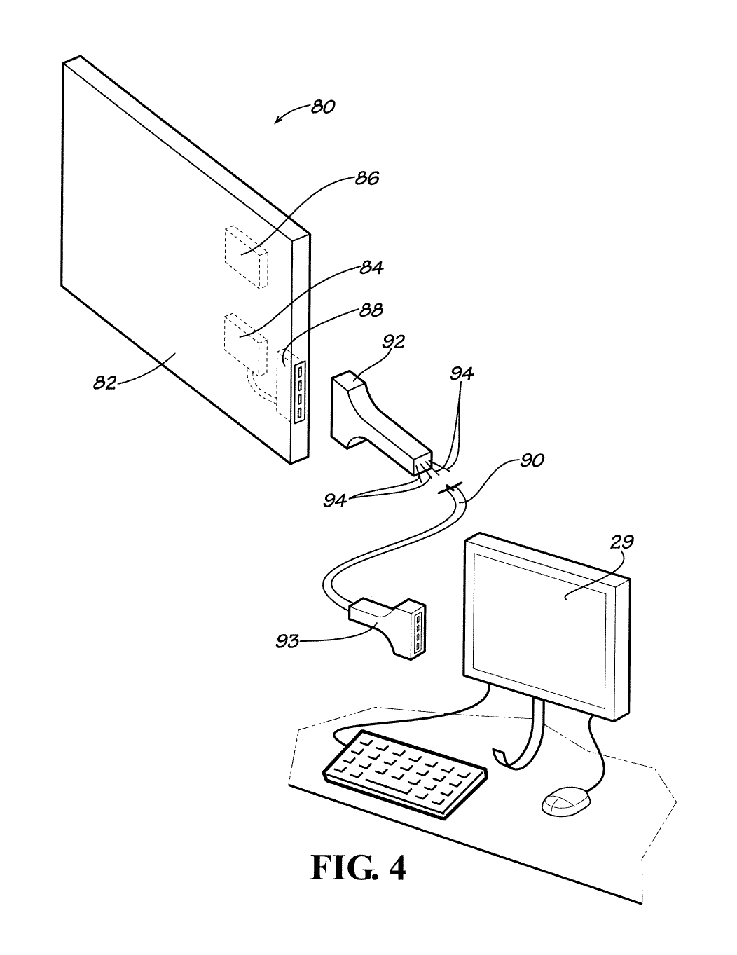

FIG. 4 illustrates an embodiment of a prescription authorization card 80 for use in accordance with prescription system 10 of the present invention. The prescription authorization card 80 comprises a compact card member 82, such as a flexibly rigid plastic sheet member of a type conventionally used for credit and debit transaction cards. Such cards have a length and a width, and a thickness substantially less than either the length or width. The card 80 includes an embedded microprocessor device 84 and a memory 86 in which patient information 17, the payer information 19, and the prescription information 21 are stored. The microprocessor 84 is configured with software instructions that upon execution, permit access to the memory 86 for entry and encoding of information, for reading stored information, and for communicating with exterior and remote computers such as is available to the prescriptionist 12, the patient, the prescription provider and distributor, or others authorized with the system 10. The card 80 includes a conventional connector 88 for electronic communications between the microprocessor 84 and such exterior and remote computers operating in accordance with the system 10. The connector 88 may be a conventional USB connector, or other connector device that readily engages a cable 90 having a mating connector 92 for electronic data exchange. In the illustrated embodiment, the cable 90 includes opposing mating connectors 92, 93. The cable 90 includes a plurality of wires 94 as logical pipes for communicating electrical signals between connected devices, such as the microprocessor computer 29 of an authorized accessor to the system 10 connected to the memory device (in the illustrated embodiment, to the prescription authorization card 80 or card 16 of the USB stick embodiment) as a peripheral electronic device. The conventional connector 88 attached to the prescription card 80 facilities implementation of the system 10 because rather than use specially configured electronic reading and writing devices 18, the authorized accessors (patient, prescriptionists, prescription provider, and prescription distributor) may rather use the conventional connector 88 that enables electronic access between the card and the computers 29 that communicate in the communications network. Many recently constructed microprocessor computers are conventionally equipped with USB or similar connectors for communication with conventional computer peripheral devices. The USB stick discussed above also provides such interface flexibility.

For example, the embodiment using the USB memory stick device or the prescription authorization card 80, the first data station communicates through the US connector of the stick device or the connector 88 to interactively encode patient information discussed above, or selectively to read such, in the electronically addressable memory device. The connector 88 similarly enables communication between the patent authorization card 16, 80 and computers 29 of authorized accessors operative within the system 10 through the communications links.

The foregoing specification describes the present invention that provides apparatus and method for medical prescription fulfillment and intercommunications among medical service providers to patients. It is to be understood, however, that numerous changes and variations may be made in the construction of the converter within the spirit and scope of the present invention and that modifications and changes may be made therein without departing from the scope thereof as set forth in the appended claims.

What is claimed is:

1. A system for fulfillment of medical prescriptions issued by a prescriptionist for one of a plurality of patients and fulfilled by a medical products supplier, comprising:
a plurality of prescription authorization devices, each having an electronically addressable memory configured for receiving at least a medical prescription and a unique identifier associated with one of a plurality of patients for whom medical prescriptions are issued by a prescriptionist;
a first data station interactively operative for encoding the electronically addressable memory of the prescription authorization device a medical prescription for the patient by the prescriptionist;
a communicator configured for communicating the medical prescription from the prescription authorization device to a medical products supplier;
a distributor identified by the patient for providing the medical product subject of the medical prescription from the medical products supplier to the patient;
a second data station configured for encoding by the distributor in the electronically addressable memory the delivery and fulfillment information for the medical prescription.

2. The system as recited in claim 1, further comprising a payment transferor that transfers payment for the medical product to the medical product supplier upon presentation of the prescription authorization device as a credit card or debit card associated with an account of funds of the patient.

3. The system as recited in claim 1, wherein the second data station operatively configured for authenticating the request by the patient to the distributor for supply of the medical product to the patient upon presentation of the prescription authorization device to the distributor.

4. The system as recited in claim 1, further comprising a second communicator configured for communicating between the distributor and a payment transferor, wherein the payment transferor verifies delivery of the medical product to the patient prior to transfer of the payment therefore.

5. The system as recited in claim 1, wherein the distributor is a service associated with the medical products provider.

6. The system as recited in claim 1, wherein the distributor authenticates the request for supply of the medical product to the patient upon presentation of the prescription authorization device to the distributor.

7. The system as recited in claim 6, further comprising a second communicator configured for verifying delivery of the medical product to the patient and notifying a third party provider of the authentication and delivery of the medical product to the patient for payment.

8. The system as recited in claim 7, further comprising an electronic funds transferor for transferring payment from the third party provider to the medical products supplier.

9. The system as recited in claim 8, wherein the prescription authorization device is encoded with a number of an account from which payment funds are supplied.

10. The system as recited in claim 1, further comprising a second communicator configured for the patient to communicate a request for refill of the medical prescription to the medical products supplier.

11. The system as recited in claim 10, further comprising the medical products provider communicating the request for refill to the prescriptionist for approval prior to providing the prescribed medical product.

12. The system as recited in claim 1, further comprising a payment transferor that transfers payment for the medical product to the medical product supplier.

13. The system as recited in claim 1, further comprising a connector for electronic communication between the prescription authorization device and a selected one of the first or second data stations.

14. The prescription authorization device of the medical information system as recited in claim 13, wherein the connector includes a plurality of electrical contacts configured for communicating via a logical pipe in a cable attached to the connector with a remote microprocessor computer of an authorized accessor operative within the system.

15. A system for fulfillment of medical prescriptions issued by a prescriptionist for one of a plurality of patients with reimbursement by a third party provider and fulfilled by a medical products supplier, comprising:
a plurality of prescription authorization cards, each having an electronically addressable memory and a unique identifier associated with one of a plurality of patients for whom medical prescriptions are issued by a prescriptionist;
a data station interactively operative for encoding the electronically addressable memory of the prescription authorization card with a medical prescription for the patient by the prescriptionist;
a communicator accessible by the patient and configured to access the medical prescription as encoded in the memory of the prescription authorization card and to communicate with the medical products supplier regarding the medical prescription;
a data storage device accessible by the medical products supplier and configured to record the medical prescription together with the identifier sent by the communicator for tracking the status of fulfillment of the medical prescription;
an electronic notice system by which the medical products supplier communicates an availability message to the patient upon fulfillment of the medical prescription,
whereby the patient being notified of the fulfillment of the medical prescription, uses the communicator to authorize delivery of the medical prescription and the communicator further configured to encode delivery and fulfillment information for the medical prescription in the electronically addressable memory of the prescription authorization card.

16. The system as recited in claim 15, further comprising a payment transferor that transfers payment for the medical product to the medical product supplier upon notification of authorization by the patient for delivery of the medical product.

17. The system as recited in claim 15, further comprising a distributor that receives the medical product subject of the medical prescription from the medical products supplier and delivers the medical product to the patient.

18. The system as recited in claim 17, wherein the distributor is a retail store associated with the medical products supplier.

19. The system as recited in claim 17, wherein the distributor comprises apparatus for receiving, transporting and delivering packages.

20. The system as recited in claim 15, further comprising a connector for electronic communications between the prescription authorization card and a selected one of the data station and communicator.

21. The system as recited in claim 20, wherein the connector includes a plurality of electrical contacts configured for communicating via a logical pipe in a cable attached to the connector with a remote microprocessor computer of an authorized accessor operative within the system.

22. A medical information system in which a plurality of authorized accessors including prescriptionists issue medical prescriptions for a plurality of patients for fulfillment by a medical products supplier, in which each patient is provided with a prescription authorization device comprising:
a housing with an embedded memory device and including a unique identifier associated with a one of a plurality of patients;
an electronic device configured for selectively reading and writing patient medical information in the memory device and configured for communicating through a communications network with a plurality of accessors that include at least one precriptionist, a medical provider, and a distributor that provides the prescribed medical product to the patient;
the memory device configured with a database of patient information, accessor information, and prescription information of a medical prescription;
the patient information including at least a number of a payment account which upon authorization is accessed for payment of a co-payment or a balance due for the medical prescription entered by one of the prescriptionists into the memory device and fulfilled by a medical provider;
the patient information further selectively including medical history information, allergy and reaction information, medical images related to the patient, medical reports, and medical tests,
whereby a referred prescriptionist or an emergency medical personnel as one of the accessors may access through a second electronic device the information recorded in the memory device of the prescription authorization device.

23. The prescription authorization device of the medical information system as recited in claim 22, further comprising a connector for electronic communication between the memory device and a remote microprocessor computer of one of the accessors.

24. The prescription authorization device of the medical information system as recited in claim 23, wherein the connector includes a plurality of electrical contacts configured for communicating via a logical pipe in a cable attached to the connector with the remote microprocessor computer.

25. A method of information exchange in a medical information system in which a plurality of authorized accessors including prescriptionists issue medical prescriptions for a plurality of patients for fulfillment by a medical products supplier, in which each patient is provided with a prescription authorization device comprising the steps of:
(a) providing to each of a plurality of patients a separate prescription authorization device that includes an embedded electronic memory device having at least a unique identifier associated with the one of the plurality of patents;
(b) configuring an electronic device for selectively reading and writing patient medical information in the memory device and for communicating through a communications network with a plurality of accessors including at least one prescriptionist, a medical provider, and a distributor that distributes a medical product prescribed by the prescriptionist to the patient;
(c) providing the memory device with patient information, accessor information, and prescription information;
the patient information including at least a number of a payment account which upon authorization is accessed for payment of a co-payment or a balance due for the product subject of the medical prescription entered by the one of the prescriptionists into the memory device and fulfilled by the medical provider; and
the patient information further selectively including medical history information, allergy and reaction information, medical images related to the patient, medical reports, and medical tests,
whereby a referred prescriptionist or an emergency medical personnel as one of the accessors may access through a second electronic device the information recorded in the electronic memory device of the prescription authorization device.

26. The method as recited in claim 25, further comprising the step of attaching a communications cable to a connector operatively engaged to the authorization device for communication between the memory device and a remote microprocessor computer of one of the accessors.
